(19) United States
(12) Patent Application Publication
(10) Pub. No.: US 2008/0004945 A1
(43) Pub. Date: Jan. 3, 2008

(54) Automated scoring of interactions

(76) Inventors: Joe Watson, Alpharetta, GA (US); James Gordon Nies, Carmel, IN (US); Damian Smith, Alpharetta, GA (US); Jamie Richard Williams, Alpharetta, GA (US)

Correspondence Address: THOMAS, KAYDEN, HORSTEMEYER & RISLEY, LLP, 600 GALLERIA PARKWAY, STE 1500, ATLANTA, GA, 30339, US

(21) Appl. No.: 11/479,056

(22) Filed: Jun. 30, 2006

(51) Int. Cl. G06F 11/34

(52) U.S. Cl. 705/11

(57) ABSTRACT

Disclosed in various embodiments are various systems, methods, and programs embodied on a computer readable medium for automated scoring of interactions. In one embodiment, an example of a method is provided that comprises the steps of storing a plurality of interactions in a memory, wherein a plurality of interactive factors are memorialized for each of the interactions, each of the interactive factors comprising an aspect of the interaction. The method also comprises the steps of applying a plurality of rules to each of the interactions to identify a plurality of events in each of the interactions, each of the rules defining at least one event that is associated with at least one of the interactive factors of a respective one of the interactions, and, generating a score in the computer system for each of the interactions based upon the rules defining the at least one event occurring in each of the interactions, respectively. The method further comprises the step of ranking at least a subset of the interactions relative to each other based upon the scores generated for the interactions.

### BACKGROUND OF THE INVENTION

In call centers, recorded or stored calls for various purposes such as sales, support, and other call center functions may be reviewed by management personnel in order to determine the work performance of agents of the call center. Often times managers of call centers will randomly chose recorded or stored calls to review in order to measure the work performance of the agents. Unfortunately, the selection of calls at random reduces the possibility that the calls of agents most needing review will actually be reviewed.

### SUMMARY OF THE INVENTION

Various systems, methods, and programs embodied on computer readable mediums are described. In one example, a method is provided for automated scoring of interactions. This method comprises the steps of storing a plurality of interactions in a memory, wherein a plurality of interactive factors are memorialized for each of the interactions, each of the interactive factors comprising an aspect of the interaction. Also, the method includes the steps of applying a plurality of rules to each of the interactions to identify a plurality of events in each of the interactions, each of the rules defining at least one event that is associated with at least one of the interactive factors of a respective one of the interactions, and, generating a score in the computer system for each of the interactions based upon the rules defining the at least one event occurring in each of the interactions, respectively. The method also comprises the step of ranking at least a subset of the interactions relative to each other based upon the scores generated for the interactions.

In another embodiment, an example system is provided for automated scoring of interactions. The system comprises a processor circuit having a processor and a memory, and a plurality of interactions stored in the memory, wherein a plurality of interactive factors are memorialized for each of the interactions, each of the interactive factors comprising an aspect of the interaction. The system further comprises an automated interaction scoring calculator stored in the memory and executable by the processor, the automated interaction scoring calculator comprises a plurality of rules defining at least one event that is associated with at least one of the interactive factors, logic that applies at least a subset of the rules to respective ones of the interactions to identify at least one event occurring in the respective ones of the interactions, logic that generates and stores a score in the memory for the respective ones of the interactions based upon the rules defining the at least one event occurring in the respective ones of the interactions, and logic that ranks at least a subset of the interactions.

In still another embodiment, an example system is provided for automated scoring of interactions. In this example embodiment, the system comprises a plurality of interactions stored in a memory, wherein a plurality of interactive factors are memorialized for each of the interactions, each of the interactive factors comprising an aspect of the interaction, and a plurality of rules defining at least one event that is associated with at least one of the interactive factors. The system further comprises means for applying at least a subset of the rules to respective ones of the interactions to identify at least one event occurring in the respective ones of the interaction, and means for generating and storing a score in the memory for the respective ones of the interactions based upon the rules defining the at least one event occurring in the respective ones of the interactions. The system further comprises means for ranking at least a subset of the interactions relative to each other based upon the scores generated for the interactions.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a drawing illustrating several interactive factors that are memorialized for an interaction in order to generate a score for the interaction according to an embodiment of the present invention;

FIG. 2 is a schematic block diagram illustrating one example of a system for automated scoring of interactions such as the interactions shown in FIG. 1 according to an embodiment of the present invention;

FIGS. 3A, 3B, and 3C are diagrams illustrating examples of rules applied by the example system of FIG. 2 in order to generate a score for an interaction as described with reference to FIG. 1 according to an embodiment of the present invention;

FIG. 4 is a flow chart illustrating one example of the operation of the example system of FIG. 2 in generating scores for interactions as described with reference to FIG. 1 according to an embodiment of the present invention;

FIG. 5 is a flow chart illustrating one example of the operation of the example system of FIG. 2 in ranking interactions based upon the scores generated for the interactions as described with reference to FIG. 1 and rendering an output of the ranked interactions according to an embodiment of the present invention; and

FIG. 6 is a flow chart illustrating a second example of the operation of the example of the system of FIG. 2 in generating scores for interactions as described with reference to FIG. 1 according to an embodiment of the present invention.

### DETAILED DESCRIPTION OF THE PREFERRED EMBODIMENT

In a typical call center, there are one or more agents that receive calls from customers or other individuals for various purposes. For example, a company might employ a call center to provide a customer support function for customers who buy major appliances or other products. As such, customers call a hot line with questions regarding their newly purchased goods, or perhaps malfunctioning goods, in order to receive help from the manufacturer. Agents in the call center would receive such calls and, with each call, an interaction between the agent and the customer occurs. In some cases, the interaction is recorded or stored for further evaluation of the performance of the agent.

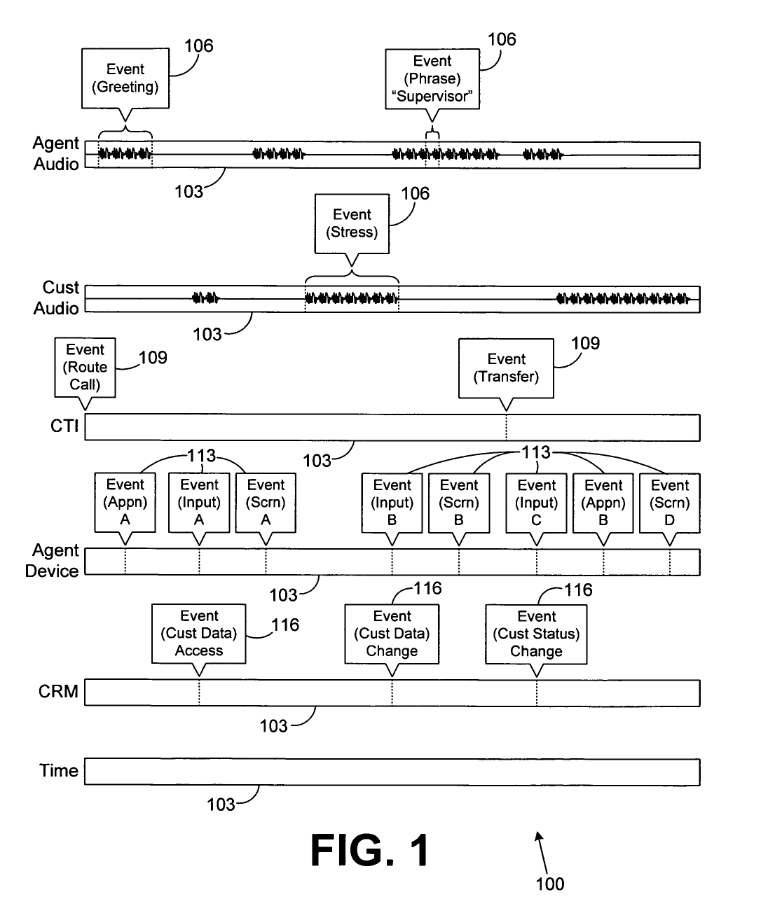

With reference to FIG. 1, shown is an example of an interaction 100 according to an embodiment of the present invention. The interaction 100 comprises a number of different interactive factors 103 that are memorialized during the recording or storing of the interaction 100 itself. Each of the interactive factors 103 comprises an aspect of the interaction 100. For example, the interactive factors 103 may comprise audio signals such as one or more channels of agent and/or customer audio recorded or stored during the interaction 100 itself. Other interactive factors might include computer telephony integration factors that relate to the operation of computer telephony that controls the telephone connections in a given call center.

Further interactive factors 103 include an agent device such as a computer or other device manipulated by a given agent during the interaction 100, or a customer relations management system with which the agent may interact during the course of the interaction 100 in obtaining and potentially changing data about a given customer. Another interactive factor 103 includes a time duration of the interaction 100. In addition, there may be other interactive factors 103 that are memorialized by being recorded or stored during an interaction 100 between a given agent and another person, where the interactive factors 103 described above are provided herein as examples.

Associated with the various interactive factors 103 are events that are defined by rules as will be described. The events generally relate to the interactive factors 103 within which they occur. For example, audio events 106 may comprise a greeting event in which the greeting provided by an agent to a given customer at the beginning of an interaction 100 is identified. Also, the audio of a given agent or customer may be analyzed for an amount of stress experienced by an individual as relayed by the audio, where a stress event might be identified therein. In addition, an utterance of a given word or phrase in the agent or customer audio may also comprise an event. In addition, many other types of audio events 106 may be defined as can be appreciated by those with ordinary skill in the art.

In addition, the interactive factor 103 related to computer telephony integration may generate one or more computer telephony integration events 109. Such events may comprise, for example, an initial receipt of a call, an initial routing of a call to an agent, a pickup by an agent, a transfer of a call between agents, placing a call on hold, or any other computer telephony integration event that may be generated by a computer telephony integration system. In this respect, the computer telephony integration system can provide information to a separate system that may then identify computer telephony integration events 109 therein.

The interactive factor 103 comprising the agent device can provide a wealth of information as to the actions of a given agent during an interaction 100 with a customer or other person. In this respect, assuming that the agent device is a computer, for example, then various agent device events 113 may be recorded. The events associated with the agent device may comprise input events, application events, screen events, or other events as can be appreciated. An application event might be an action taken on the part of an agent to start up or manipulate an application on the agent device, or the agent device comprises, for example, a computer system. Similarly, the input event 113 may comprise, for example, the specific input into a computer system or other device made by an agent during the course of an interaction 100 such as keyboard input, mouse input, or other input.

The screen events 113 associated with the agent device relate to the screens that the agent sees during the interaction 100 that are generated based upon actions taken on the part of an agent. For example, the screen events 113 may comprise the various different screens of information an agent accesses from a database for a given customer, or the appearance of data or change of data resulting from the actions of a given agent. In addition, there may be many other agent device events 113, depending upon the particular device manipulated by the agent that may be recorded or stored as part of an interaction 100.

The customer relations management system (CRM) provides for customer relations management events 116. The customer relations management events may comprise, for example, accessing customer data about a given customer, changing data about a given customer, changing a status of a given customer relative to an organization, or other action. The status of a given customer according to the given organization is, of course, relative to the type of organization. For example, where the call center is associated with a bank, then a status of a customer may relate to a customer's account such as, for example, whether the account is open or closed. There may be many other types of customer relations management system events 116 that may be identified from the information received from a customer relations management system as can be appreciated.

In addition, the interactive factors 103 include time that may be related to the length or duration of the interaction 100 itself. In this respect, each of the events 106, 109, 113, or 116 may be related to each other in time as can be appreciated. In addition, the time between various events may be an event itself such as, for example, a significant period of silence during an interaction. Note that time may be memorialized as a part of the other interactive factors 103 rather than being memorialized as its own separate factor.

By memorializing each of the interactive factors 103 during the course of a given interaction 100, a lot of information is recorded or stored from which a score may be derived that evaluates the performance of the agent during the course of the interaction 100 itself. In this respect, the performance of the agent during the course of the interaction may be automatically evaluated and a corresponding score generated. According to an embodiment of the present invention, a number of scores are generated automatically for a corresponding number of different interactions 100. The interactions 100 may then be ranked relative to each other based upon the scores generated. In this manner, an automated scoring of interactions is achieved.

The relative ranking of the scores provides context within which the individual scores become meaningful. In particular, given scores taken on an individual basis might not provide accurate information relative to a given interaction. However, weighing the scores of the interactions 100 relative to each other provides context that makes the automated scoring function for all of the interactions 100. In addition, the automated scoring functions may be improved over time based upon an examination of the relative ranking of the scores as will be described.

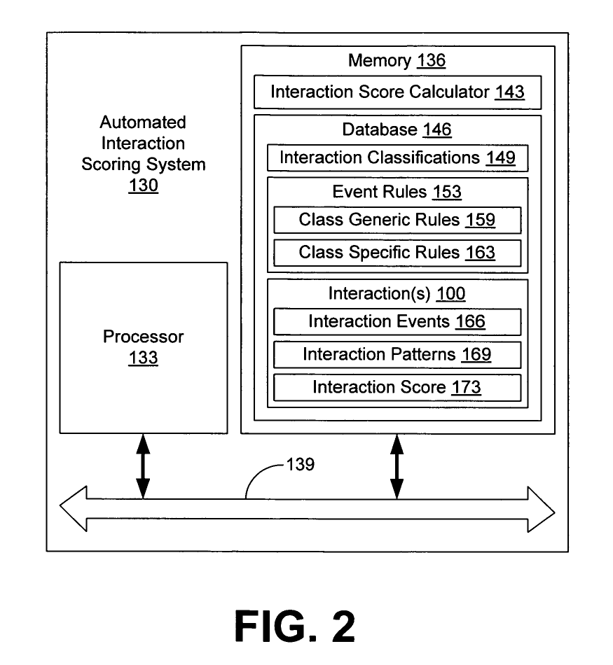

Referring next to FIG. 2, shown is one example of an automated interaction scoring system 130 according to an embodiment of the present invention. The automated interaction scoring system 130 includes a processor 133 and a memory 136, both of which are coupled to a local interface 139. The local interface may comprise, for example, a data bus with an accompanying control/address bus as can be appreciated by those with ordinary skill in the art. In this respect, the automated interaction scoring system 130 may comprise a computer system or server, etc.

Stored in the memory 136 and executable by the processor 133 is an interaction score calculator 143. In addition, an operating system may also reside in the memory 136 and is executed by the processor 133 as can be appreciated. In this respect, the interaction score calculator 143 may be executed on top of the operating system as can be appreciated.

Also stored in the memory 136 is a database 146. The database includes various information such as, for example, interaction classifications 149, event rules 153, and interactions 100. The event rules 153 may comprise class generic rules 159, and class specific rules 163. The event rules 153 are employed to identify events 106, 109, 113, or 116 (FIG. 1) or patterns of the events as will be described. In this respect, the interactions 100 may comprise, for example, interaction events 166, interaction patterns 169, and an interaction score 173. Interactions 100 may also comprise the recorded or stored information representing the interactive factors 103 that make up the interaction 100.

A number of software components are stored in the memory 136 and are executable by the processor 133. In this respect, the term “executable” means a program file that is in a form that can ultimately be run by the processor 133. Examples of executable programs may be, for example, a compiled program that can be translated into machine code in a format that can be loaded into a random access portion of the memory 136 and run by the processor 133, or source code that may be expressed in proper format such as object code that is capable of being loaded into a of random access portion of the memory 136 and executed by the processor 133, etc. An executable program may be stored in any portion or component of the memory 136 including, for example, random access memory, read-only memory, a hard drive, compact disk (CD), floppy disk, or other memory components.

The memory 136 is defined herein as both volatile and nonvolatile memory and data storage components. Volatile components are those that do not retain data values upon loss of power. Nonvolatile components are those that retain data upon a loss of power. Thus, the memory 136 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, the processor 133 may represent multiple processors and the memory 136 may represent multiple memories that operate in parallel. In such a case, the local interface 139 may be an appropriate network that facilitates communication between any two of the multiple processors, between any processor and any one of the memories, or between any two of the memories etc. The processor 133 may be of electrical, optical, or molecular construction, or of some other construction as can be appreciated by those with ordinary skill in the art.

The interaction classifications 149 each define a type or class of interaction 100 according to an embodiment of the present invention. In this respect, the interactions 100 may relate to specific subject matter or may be of a specific type. For example, a given company may have call centers for sales support functions, accounting or billing functions, and/or customer service functions. Each one of these types of functions might be considered an interaction classification 149. In some situations, the classification of a given interaction 100 may be known at the beginning of the interaction itself. For example, the computer telephony integration system may route specific calls to specific call centers based upon the type of interaction 100 requested based upon the manipulation of an automated menu by a caller, or via transfer by an operator. Alternatively, a classification may be determined by analyzing an interaction 100 itself.

Given that there may be many different interaction classifications, the event rules 153 may or may not relate to all of the interaction classifications 149. In particular, the class generic rules 159 may be rules that are applied to an interaction 100 regardless of the interaction classification 149 associated therewith in order to identify events within such interaction 100. Class generic rules 159 may comprise, for example, audio events 106 (FIG. 1) such as uttering certain words or phrases such as profanity, or other words or phrases that may affect an automated scoring of a given interaction regardless of the classification 149 of the interaction 100.

On the other hand, class specific rules 163 may relate only to specific ones of the interaction classifications 149. For example, a class specific rule 163 may define various screen events 113 associated with an agent device for a given system that is employed for the function that is associated with the interaction classification 149. Specifically, assuming that the interaction classification 149 of a given interaction 100 is a billing classification, then the screen events 113 might comprise the screens associated with an accounting system accessed by the agent. As such, a class specific rule 163 may identify the various screen events 113 that occur throughout the interaction 100 that are associated with the respective classification 149 of the interaction 100. According to one embodiment of the present invention, depending on the interaction classification 149 of a given interaction 100, the class generic rules 159 and specific ones of the class specific rules 163 may be applied by the interaction score calculator 143 to generate an interaction score 173 for the interaction 100.

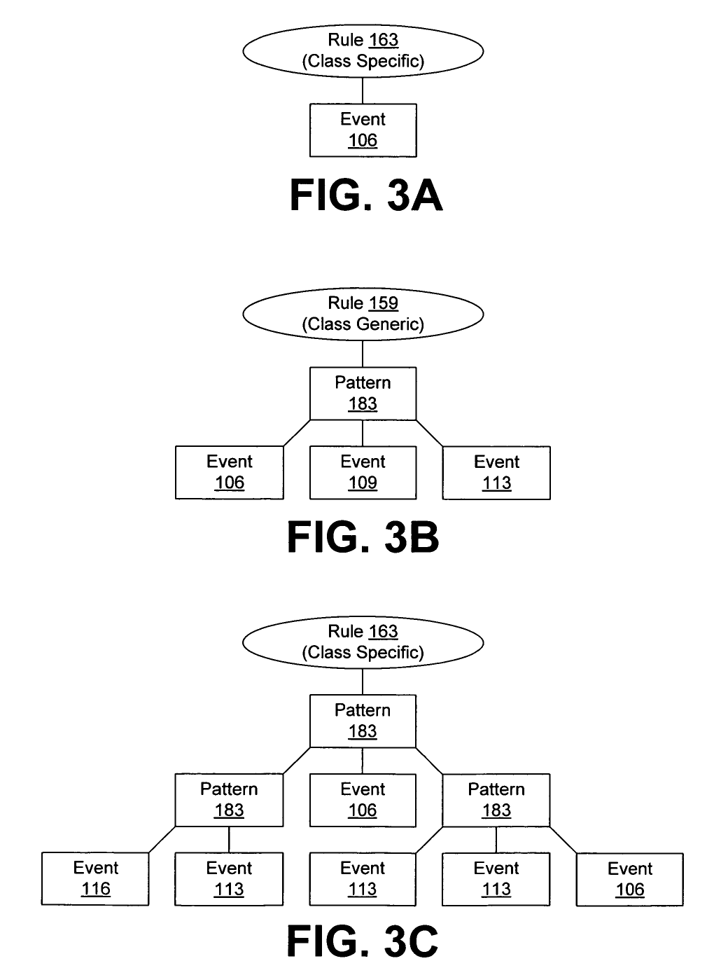

With reference to FIGS. 3A, 3B, and 3C, shown are block diagrams that illustrate the nature of class generic rules 159 and class specific rules 163 according to an embodiment of the present invention. In one embodiment, in FIG. 3A, a class specific rule 163 is shown that comprises a single audio event 106. In this respect, this may be the detection of an utterance of a given phrase or word, such as profanity or other phrase or word. Alternatively, the rule 163 may define any other type of single event as described above.

Next, in FIG. 3B, shown is a class generic rule 159 that defines a pattern 183. The pattern 183 specifies a number of events. In particular, the pattern 183 defines an audio event 106, a computer telephony integration event 109, and an agent device event 113. Although a given pattern of events 106, 109, and 113 is shown, the pattern 183 may define any number of events, and the events defined by the pattern may be any combination of events possible based upon how a given interaction 100 is to be scored.

Next, with reference to FIG. 3C, shown is a class specific rule 163 that is an upper level pattern that further defines patterns and events. In particular, the rule 163 defines an upper level pattern 183 that, in turn, defines a series of a pattern 183, an event 106, and a pattern 183. The second level patterns 183 comprise events 116 and 113, or events 113, 113, and 106. Thus, a pattern 183 defined by a rule 159 or 163 may comprise multiple events, multiple patterns, or any combination of the two. In this respect, a rule 159 or 163 may define a hierarchy of patterns and events as described above.

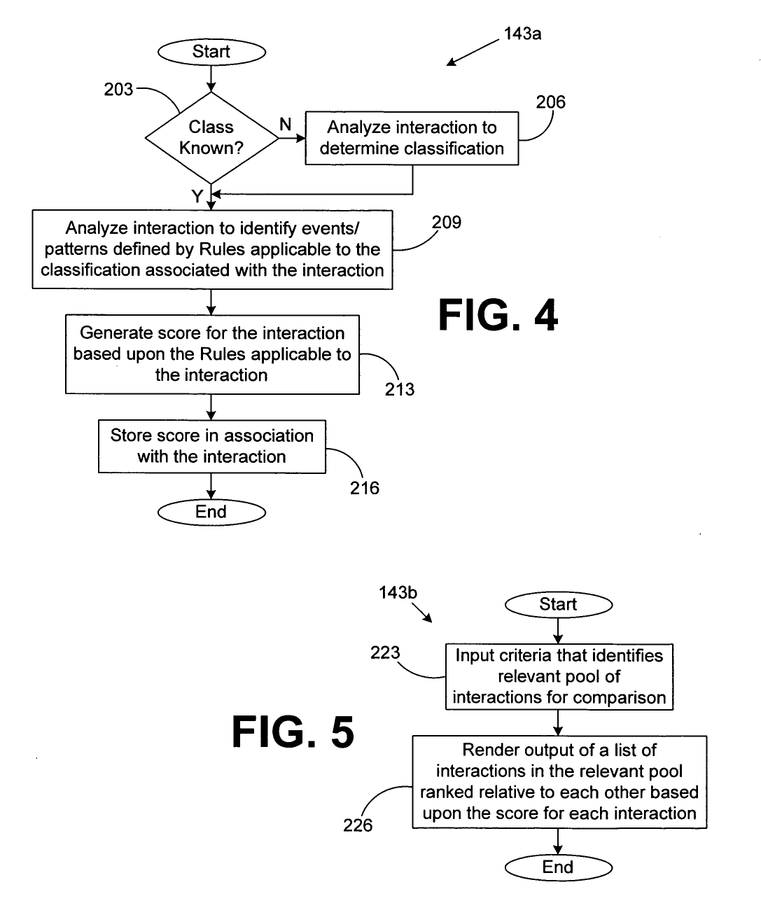

Referring next to FIG. 4, shown is a flow chart that provides one example of the operation of the interaction score calculator 143, denoted herein as interaction score calculator 143a, according to an embodiment of the present invention. Alternatively, the flow chart of FIG. 4 may be viewed as depicting steps of an example of a method implemented in the automated interaction scoring system 130 to generate an automated score of an interaction 100. The functionality of the interaction score calculator 143a as depicted by the example flow chart of FIG. 4 may be implemented, for example, in an object oriented design or in some other programming architecture. Assuming the functionality is implemented in an object oriented design, then each block represents functionality that may be implemented in one or more methods that are encapsulated in one or more objects. The interaction score calculator 143a may be implemented using any one of a number of programming languages such as, for example, C, C++, or other programming languages.

Beginning with Box 203, first it is determined whether the interaction classification 149 is known with respect to the given interaction 100 to be examined for which an interaction score 173 is to be generated. If the classification is unknown, then the interaction score calculator 143a proceeds to Box 206. Otherwise, the interaction score calculator 143a progresses to Box 209.

In Box 206, the interaction 100 is analyzed to determine the corresponding interaction classification 149. In this respect, the various events that occur during the course of the interaction 100 may be examined to identify the respective interaction classification 149. Thereafter, the interaction score calculator 143a progresses to Box 209.

In Box 209, the interaction score calculator 143a analyzes the interaction 100 to identify the events 106, 109, 113, or 116 and/or patterns 183 defined by the rules 153 applicable to the interaction classification 149 associated with the interaction 100. Thereafter, in Box 213, an interaction score 173 is generated for the interaction 100 based upon the rules 159 applicable to the interaction 100. In this respect, each rule defines the number of events or patterns, and a value may be associated with the rule that is employed to calculate the ultimate interaction score 173.

To explain further, where the event or pattern associated with a given rule is found in a given interaction, then the value associated therewith may be employed in calculating the interaction score 173. In this respect, there may be many different ways of calculating an interaction score 173. For example, the values themselves may be added to a score when given rules 153 are implicated in a given interaction 100. Also, negative values may be associated with given rules 153 that result in subtraction of a value from a given interaction score 173. In addition, the interaction score 173 may start as a zero value or may start as some other value that may be increased or decreased depending upon whether points are added or subtracted as set forth in respective rules.

Given that each of the interactions 100 is analyzed based on the same rules 153 specified, then the interaction scores 173 may be employed to rank the interactions 100 relative to each other. In this respect, the relative ranking of the interaction scores 173 of the interactions 100 are meaningful. As a result, the relative ranking of the interaction scores 173 may identify those interactions 100 that indicate quality performance on the part of an agent, whereas others may indicate very poor performance on the part of an agent relative to their peers.

Once the interactive score 173 is calculated in Box 213, then the interaction score calculator 143a proceeds to Box 216 in which the interaction score 173 is stored in association with the interaction 100. Thereafter, the interaction score calculator 143a ends.

In addition, the interactive score calculator 143a may include other functionality not described herein, where the flow chart of FIG. 4 is provided as an example of the high level function that may be employed.

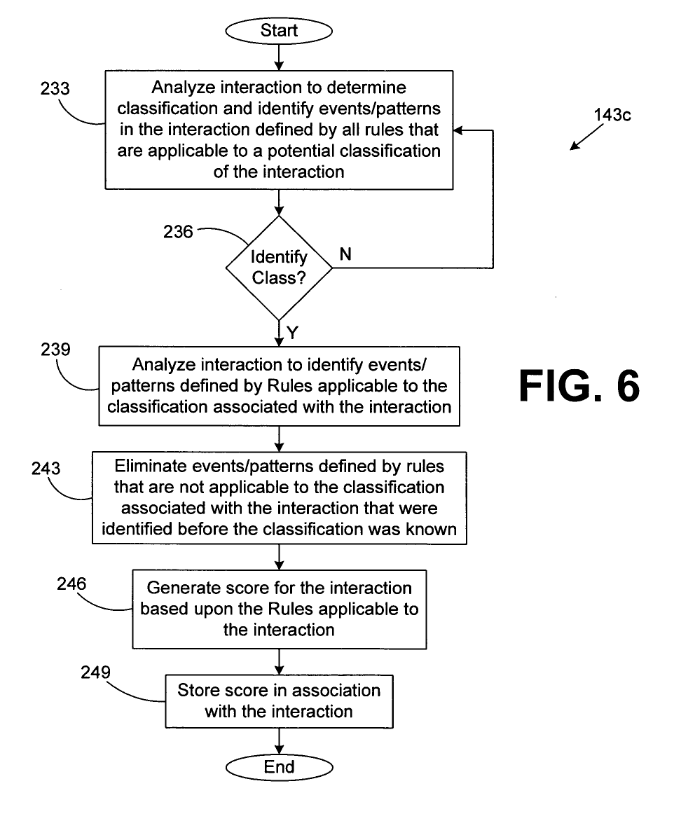

Referring next to FIG. 5, shown is a flow chart that provides one example of the operation of further functionality of the interaction score calculator 143, denoted as interaction score calculator 143b, in rendering a relative ranking of interactions 100 (FIG. 1) based on the scores 173 (FIG. 2) according to an embodiment of the present invention. Alternatively, the flow chart of FIG. 5 may be viewed as depicting steps of an example of a method implemented in the automated interaction scoring system 130 (FIG. 2) to render the relative ranking of interactions 100 based on the scores 173. The functionality of the interaction score calculator 143b as depicted by the example flow chart of FIG. 5 may be implemented, for example, in an object oriented design or in some other programming architecture. Assuming the functionality is implemented in an object oriented design, then each block represents functionality that may be implemented in one or more methods that are encapsulated in one or more objects. The interaction score calculator 143b may be implemented using any one of a number of programming languages such as, for example, C, C++, or other programming languages.

Beginning at Box 223, the interactive score calculator 143b inputs criteria that identify a relevant pool of interactions 100 for comparison in a ranking relative to each other. Thereafter, in Box 226, the interaction score calculator 143b renders an output of a list of the interactions 100 in the relevant pool of interactions that are ranked relative to each other based upon the score 173 for each respective interaction 100. The output list may be rendered in the form of a graphical user interface on a computer screen, on paper in the form of a printed list, or in some other manner as can be appreciated by those with ordinary skill in the art.

In addition, there may be other ways of presenting a relevant pool of interactions 100 ranked relative to each other based upon the interaction scores 173 other than those described here.

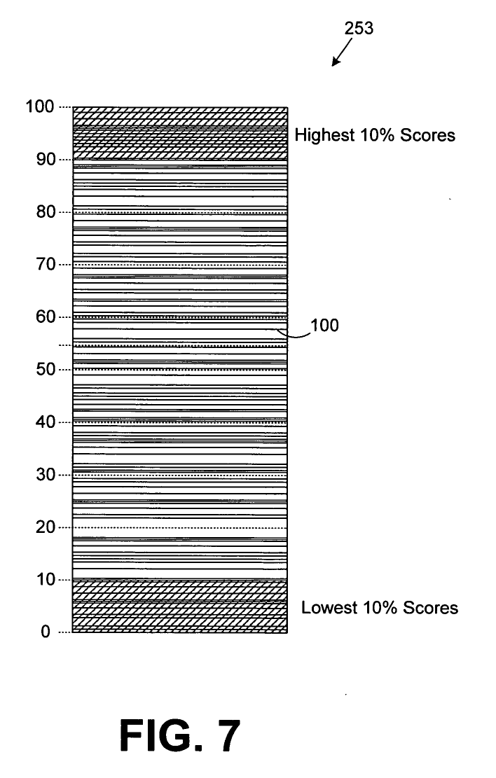

Referring next to FIG. 6, shown is a flow chart that provides one example of the operation of the interaction score calculator 143, denoted herein as interaction score calculator 143c, according to an embodiment of the present invention. Alternatively, the flow chart of FIG. 6 may be viewed as depicting steps of an example of another method implemented in the automated interaction scoring system 130 to generate an automated score of an interaction 100. The functionality of the interaction score calculator 143c as depicted by the example flow chart of FIG. 6 may be implemented, for example, in an object oriented design or in some other programming architecture. Assuming the functionality is implemented in an object oriented design, then each block represents functionality that may be implemented in one or more methods that are encapsulated in one or more objects. The interaction score calculator 143c may be implemented using any one of a number of programming languages such as, for example, C, C++, or other programming languages.

The interaction score calculator 143c is employed to generate the interaction scores 173 (FIG. 2) for interactions 100 and to identify the interaction classification 149 (FIG. 2) for the interactions 100 during active recording or storing of the interaction 100 before it is completed.

Beginning in Box 233, the interaction score calculator 143c analyzes the interaction 100 to determine both the interaction classification 149 and to identify events and patterns in the interaction as defined by the rules 153 that are applicable to all potential classifications 149 that may apply to the given interaction 100. In this respect, the interaction 100 is happening, however, the classification 149 of such interaction 100 is unknown. As such, all rules 153 that may potentially apply to the respective interaction 153 are employed to analyze the interaction 100 as it occurs to identify the respective events and patterns therein.

Next, in Box 236, it is determined whether the classification 149 of the interaction 100 has been determined. If not, then the interaction score calculator 143c reverts back to Box 233. Otherwise, the interaction score calculator 143 proceeds to Box 239. In this respect, the interaction 100 is continually examined to identify events using all rules that could potentially apply until the interaction classification 149 is known.

Assuming that the interaction score calculator 143 has proceeded to Box 239, then the interaction classification 149 of the interaction 100 is known. Consequently, from this point forward, the interaction 100 is analyzed based upon the rules applicable to the given classification 149 that is associated with the interaction 100 to identify the events and patterns in the interaction 100 related to the relevant rules 153.

Next, in Box 243, those events and patterns defined by rules 153 that are not applicable to the given classification 149 that were identified in the interaction 100 before the classification was known are eliminated. This is because such events and patterns defined by such rules 153 do not apply to the interaction 100 and, therefore, are unnecessary. Thereafter, in Box 246, the score of the interaction 100 is generated based upon values associated with the rules 153 that define the events and patterns identified in the interaction 100. In this respect, the scores are generated in Box 246 in a manner similar to that described above with respect to Box 213 (FIG. 4). Next, the interaction score calculator 143c proceeds to Box 249 in which the interaction score 173 calculated in Box 246 is stored in a memory in association with the interaction 100 itself. Thereafter, the interaction score calculator 143 ends accordingly.

Thus, the flow chart of FIG. 6 provides a second embodiment of the interaction score calculator 143. In this respect, the interaction score calculator 143c may also include other functionality not described herein, where the flow chart of FIG. 6 describes the operation of the interaction score calculator 143 on a relatively high level according to the various embodiments of the present invention.

With respect to FIG. 7, shown is a depiction of a rendering of a ranking of interactions 100 relative to each other accordingly to an embodiment of the present invention. The ranking of the interactions 100 may be indicated in a graphical user interface, on paper (printing), or via some other approach. In this respect, each of the lines 100 represents a given interaction 100 that exists on a scale from 0% to 100%. According to various embodiments of the present invention, the relative ranking of the interactions 100 based upon their interaction scores 173 allows management to identify those interactions 100 that fall within a highest predefined percentage of the total of interactions 100 in the relevant pool of interactions identified. Similarly, management can identify the interactions 100 that fall within a lowest predefined percentage of the total interactions in the relevant pool of interactions identified.

The interactions 100 that fall within the highest predefined percentage of total interaction scores 173 may be employed by management in order to refine the rules 153 so that they increase the accuracy of the scoring performed. Likewise, those interactions 100 that fall within the lowest predefined percentage of the total interactions based upon the interaction scores 173 may be examined and the rules 153 may also be adjusted accordingly.

Also, the interactions 100 that fall within the highest and lowest predefined percentages based upon the interaction scores 173 may be examined in order to properly evaluate the performance of given agents. This may be done without having to select a random sampling of the interactions 100 that may be concentrated in the middle percentages of interactions 100 according to the relative ranking. As such, the interactions 100 that fall within the highest and lowest predefined percentage of interactions based upon interaction scores 173 will provide more meaningful information about such interactions that may indicate the desirability of evaluating manually these interactions 100 rather than the remaining ones of the interactions 100. For example, it may be desirable to perform a manual review of those interactions with scores falling in the lowest predefined percentage of interactions 100 as these interactions 100 may indicate potential areas in which the corresponding agents need to improve.

The interaction score calculator 143 as depicted in the various embodiments of the present invention can be implemented in hardware, software, firmware, or a combination thereof. In the preferred embodiment(s), the same is implemented in software or firmware that is stored in a memory and that is executed by a suitable instruction execution system. If implemented in hardware, as in an alternative embodiment, the interaction score calculator 143 can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The flow charts of FIGS. 4-6 show the architecture, functionality, and operation of a possible implementations of the interaction score calculator 143. In this regard, each block represents a module, segment, or portion of code, which comprises one or more executable instructions for implementing the specified logical function(s). It should also be noted that in some alternative implementations, the functions noted in the blocks may occur out of the order noted in FIGS. 4-6. For example, two blocks shown in succession in FIG. 4-6 may in fact be executed substantially concurrently or the blocks may sometimes be executed in the reverse order, depending upon the functionality involved, as will be further clarified hereinbelow.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

In one embodiment, the interaction score calculator 143 is embodiment in software comprising an ordered listing of executable instructions for implementing logical functions that can be embodied in any computer-readable medium for use by or in connection with an instruction execution system or apparatus, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system or apparatus. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of the present invention includes embodying the functionality of the preferred embodiments of the present invention in logic embodied in hardware or software-configured mediums.

It should be emphasized that the above-described embodiments of the present invention are merely possible examples of implementations set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A method for automated scoring of interactions, comprising:
storing a plurality of interactions in a memory, wherein a plurality of interactive factors are memorialized for each of the interactions, each of the interactive factors comprising an aspect of the interaction;
applying a plurality of rules to each of the interactions to identify a plurality of events in each of the interactions, each of the rules defining at least one event that is associated with at least one of the interactive factors of a respective one of the interactions;
generating a score in the computer system for each of the interactions based upon the rules defining the at least one event occurring in each of the interactions, respectively; and
ranking at least a subset of the interactions relative to each other based upon the scores generated for the interactions.

2. The method of claim 1, further comprising the step of identifying a subset of the interactions to be ranked relative to each other based upon the scores generated for each of the interactions.

3. The method of claim 1, further comprising the step of identifying one of a plurality of classifications for each respective one of the interactions.

4. The method of claim 3, wherein a subset of the rules is associated with each of the classifications, each of the subsets of rules being unique with respect to each other.

5. The method of claim 1, wherein at least one of the rules defines a pattern of the events.

6. The method of claim 5, wherein the step of generating the score in the computer system for each of the interactions further comprises generating the score based upon the rules defining the pattern of events occurring in respective ones of the interactions.

7. The method of claim 1, further comprising the step of manually reviewing predefined lowest percentage of all of the interactions based upon the ranking of the plurality of interactions relative to each other based upon the scores.

8. The method of claim 7, further comprising the step of manually reviewing predefined highest percentage of all of the interactions based upon the ranking of the plurality of interactions relative to each other based upon the scores.

9. The method of claim 7, further comprising the step of refining the rules in response to the manual review of the predefined highest percentage of all of the interactions.

10. A system for automated scoring of interactions, comprising:
a processor circuit having a processor and a memory;
a plurality of interactions stored in the memory, wherein a plurality of interactive factors are memorialized for each of the interactions, each of the interactive factors comprising an aspect of the interaction;
an automated interaction scoring calculator stored in the memory and executable by the processor, the automated interaction scoring calculator comprising:
a plurality of rules defining at least one event that is associated with at least one of the interactive factors;
logic that applies at least a subset of the rules to respective ones of the interactions to identify at least one event occurring in the respective ones of the interactions;
logic that generates and stores a score in the memory for the respective ones of the interactions based upon the rules defining the at least one event occurring in the respective ones of the interactions; and
logic that ranks at least a subset of the interactions relative to each other based upon the scores generated for the interactions.

11. The system of claim 10, wherein the automated interaction scoring calculator further comprises:
a plurality of classifications, each of the classifications indicating a type of interaction; and
logic that determines a classification for each of the interactions.

12. The system of claim 11, wherein the rules further comprise at least one classification specific rule that is associated with a respective one of the classifications.

13. The system of claim 11, wherein the rules further comprise at least one classification generic rule that is generic with respect to all of the classifications.

14. The system of claim 10, wherein the automated interaction scoring calculator further comprises logic that facilitates a specification of at least the subset of the interactions to be ranked based upon the score for the interactions.

15. The system of claim 14, wherein the automated interaction scoring calculator further comprises logic that renders a list of the subset of the interactions ranked based upon the score for the interactions.

16. The system of claim 10, wherein at least one of rules define a pattern of the events.

17. The system of claim 10, wherein at least one of rules define a plurality of patterns of the events.

18. The system of claim 10, wherein at least one of rules define both at least one of the events and at least one pattern of the events.

19. A system for automated scoring of interactions, comprising:
a plurality of interactions stored in a memory, wherein a plurality of interactive factors are memorialized for each of the interactions, each of the interactive factors comprising an aspect of the interaction;
a plurality of rules defining at least one event that is associated with at least one of the interactive factors;
means for applying at least a subset of the rules to respective ones of the interactions to identify at least one event occurring in the respective ones of the interactions;
means for generating and storing a score in the memory for the respective ones of the interactions based upon the rules defining the at least one event occurring in the respective ones of the interactions; and
means for ranking at least a subset of the interactions relative to each other based upon the scores generated for the interactions.

20. The system of claim 10, wherein the automated interaction scoring calculator further comprises:
a plurality of classifications, each of the classifications indicating a type of interaction; and
means for determining a classification for each of the interactions.
